(19) United States
(12) Patent Application Publication
(10) Pub. No.: US 2018/0206069 A1
(43) Pub. Date: Jul. 19, 2018

(54) INTERACTIVE TOUR SYSTEM

(71) Applicant: Alexis Santos, Kissimmee, FL (US)

(72) Inventor: Alexis Santos, Kissimmee, FL (US)

(21) Appl. No.: 15/868,585

(22) Filed: Jan. 11, 2018

Related U.S. Application Data
(60) Provisional application No. 62/447,495, filed on Jan. 18, 2017.

(51) Int. Cl. H04W 4/021; G07C 11/00; H04W 4/02

(52) U.S. Cl. CPC H04W 4/021; H04W 4/026; H04W 4/023; G07C 11/00

(57) ABSTRACT

A tour system or device and a method using the system or device that comprises a location element tracked by e.g. GPS or RFID, and optionally comprises sensor elements such as an accelerometer, gyroscope or temperature sensor and acoustic detector, that allows a multitude of interactive sensory effects or feedback and creates a feeling of immersion that is fully aligned with the theme and atmosphere of the tour experience. The system, device and method provide real time or near-real time interactive sensory feedback and effects based on a user's change in location, orientation, temperature or acoustics. The system, device and method is flexible with regard to number of different effects, and number of changes in location or direction that trigger them. A plurality of user devices may interact with each other as part of an immersive tour experience.

### CROSS REFERENCE TO RELATED APPLICATIONS

This application claims the benefit of U.S. Provisional Pat. App. No. 62/447,495 filed on Jan. 18, 2017 and entitled “INTERACTIVE TOUR SYSTEM”, the entire disclosure of which is hereby incorporated by reference in its entirety:

### FIELD OF THE INVENTION

The present invention generally relates to a tour system, device and method of using it wherein the system/device provides interactive sensory effects based on a user's location in proximity to a point of interest, or interactive feedback based on a user's change in location, direction, orientation or other status, without requiring the user to step out of the immersive experience to prompt effects with incongruous input actions, such as manual typing.

### BACKGROUND OF THE INVENTION

Presently available devices or systems primarily rely on the entry of manual input, for example, numbers associated with locations or objects in a museum or amusement park, or other points of interest. In case of more advanced devices, a bar code/QR code can be scanned by the user instead. On providing a manual entry, the device will provide information, e.g. play audio or, if equipped with a screen, a video recording or show a graphic user interface where the user manually selects which information to play back or display. Smartphone apps that provide the described features similarly are initiated by the user and require user input, typically by scanning of a code with the smart phone camera, or other manual user entry or user signal. All these devices rely on specific user input that disrupts the flow of events and provides an incongruous experience not in theme with the tour or experience offered, which lessens or breaks the feeling of immersion and atmosphere. Another known device requires transmitters placed in advance e.g. at a particular attraction in an amusement park that causes a particular light effect when the transmitter is in reach of the device, and require a 2^{nd} transmitter to turn back to a default mode. Typically these devices allow to program only a very limited number of effects. Other devices require remote control by a tour operator. Another example are toys that play audio messages when particular attractions are reached in a theme park, or when a particular mobile theme character is encountered. These systems similarly use local transmitters placed in advance at a location or placed in advance with a mobile theme character in a theme park. All these systems are limited in their flexibility, adaptability and ability to create a fully immersive experience.

Therefore, there is a need in the art for a flexible system, device and method that allows a multitude of easily adaptable interactive sensory effects and creates a feeling of immersion that is fully aligned with the theme and atmosphere of the tour experience.

### SUMMARY OF THE INVENTION

Accordingly, embodiments of the present invention are directed to a tour system, device, and method of using the system wherein the system provides immediate sensory effects based on a user's location in proximity to a point of interest. The sensory effect may take the form of interactive feedback based on a user's change in location, direction, orientation of the tour device or other status change as determined by one or more sensor element. The sensory effects are provided without requiring the user to step out of the experience to prompt effects with incongruous input actions, i.e. it does not require specific user entry in manual or similar form by typing, pressing a button, or specific dedicated voice commands. Certain embodiments of the system, devices and methods do not require transmitters to be placed in advance at points of interest to trigger the effects. Certain embodiments of the system, devices and methods are flexible with regard to number of different effects, and number of changes in location, direction of movement or orientation that trigger them. Further, particular embodiments of the system, device and method allow a plurality of user devices to interact with each other as part of the immersive tour experience.

The foregoing summary of the present invention with its preferred embodiments should not be construed to limit the scope of the invention. It will be apparent to one skilled in the art that based on the embodiments as described, features of the invention may be further combined or modified without departing from its scope.

### BRIEF DESCRIPTION OF THE DRAWINGS

Accompanying this written specification is a collection of drawings of exemplary embodiments of the present invention. One of ordinary skill in the art would appreciate that these are merely exemplary embodiments, and additional and alternative embodiments may exist and still within the spirit of the invention as described herein.

### Drawings

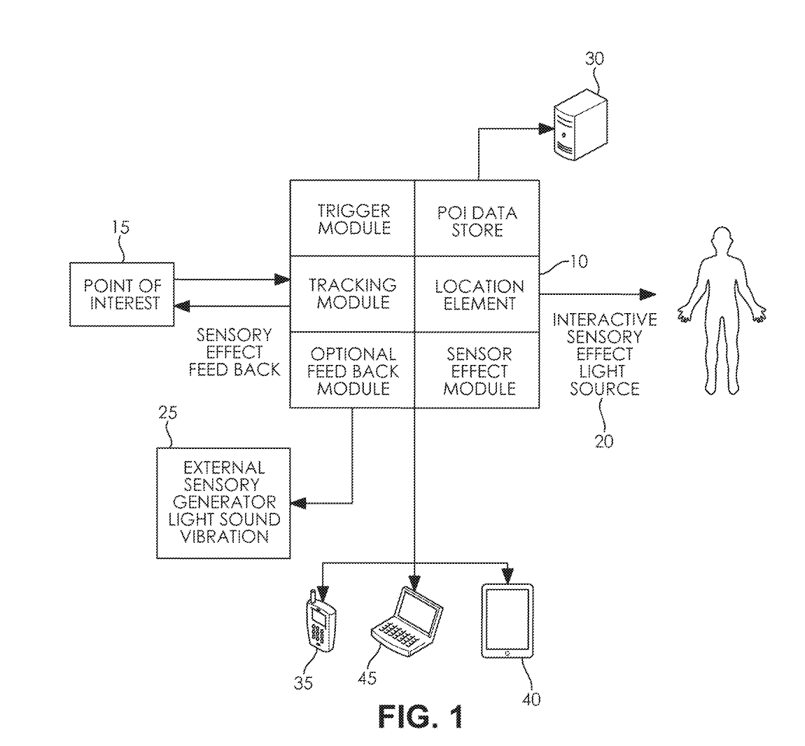

FIG. 1 Depicts a Standalone Personal Interactive Tour Device, in accordance with and embodiment of the present invention.

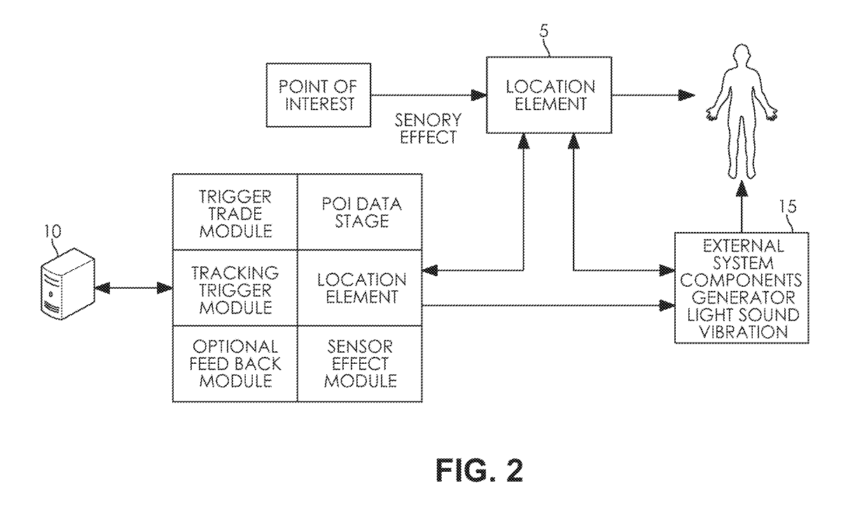

FIG. 2 Depicts an Interactive Tour Device External Configuration, in accordance with and embodiment of the present invention.

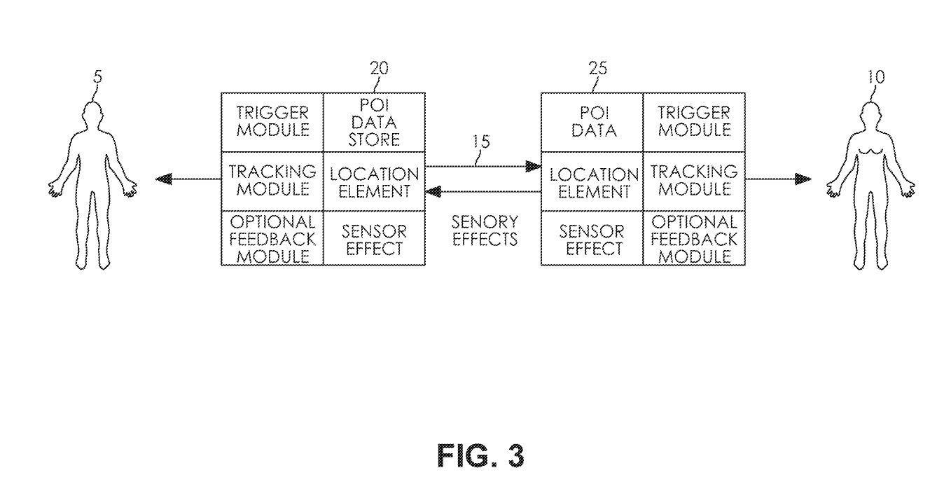

FIG. 3 Depicts Remote Interactions with Other Interactive Tour Devices, in accordance with and embodiment of the present invention.

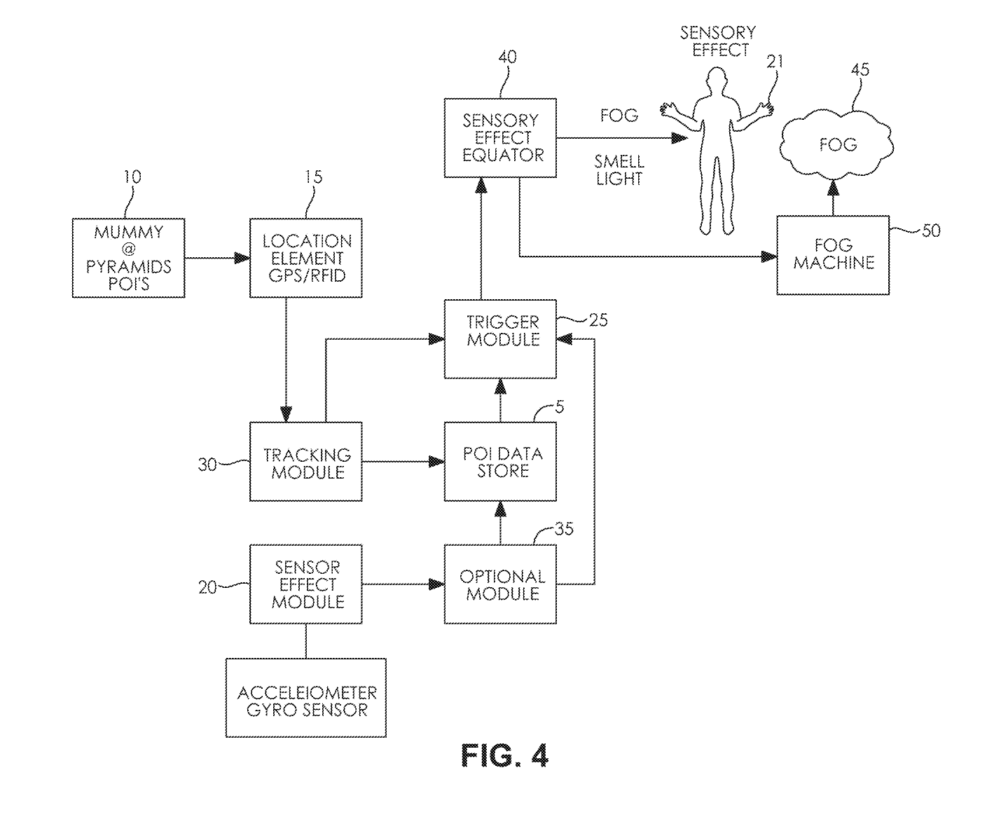

FIG. 4 Depicts the Flow of Data in Interactive Tour Device, in accordance with and embodiment of the present invention.

### DETAILED DESCRIPTION OF THE INVENTION

Turning to FIG. 1. the present invention generally relates to an interactive system that comprises a tour device with a location element 10 that can be tracked, typically by GPS, that depending on different particular locations/points of interest 15, or depending on the direction that the tour device is pointed at, automatically and interactively triggers different interactive sensory effects 20 or feedback the type of which corresponds to the point of interest and/or orientation of the device towards a point of interest. In certain preferred embodiments, the tour system creates real-time or near real-time interactive feedback to a user's movements, orientation, status, and changes thereof, that may be fully automated and allows for a unique immersive experience.

The tour device may be a personal stand-alone device as in FIG. 1. (i.e. the tour device itself is the tour system), or the device carried by the user may be part of a system that remotely interacts with the tour device as depicted in FIG. 2, e.g. via Wi-Fi. The tour device comprises a location element 10 in FIG. 1 to determine a user's location, such as, but not limited to circuitry for providing geolocation, GPS circuitry, RFID systems, components of the or any combination thereof. One of ordinary skill in the art would appreciate that there are numerous methods for determining a user's location, and embodiments of the present invention are contemplated for use with any appropriate method of determining user location.

Turning to FIG. 2 the tour device may also comprise one or more other system components that alternatively may be external system components 15 as described herein-below. If all system components are external, then the tour device may comprise only the location element 5 for tracking of its location (e.g. an electronic ID or RFID tag), and/or an element or sensor to track its orientation (e.g. an accelerometer and/or gyro sensor). In some embodiments, the tour device comprises one or more external sensory effect generator 25 in FIGS. 1 and 15 in FIG. 2 (e.g. a source of light, sound, or another sensory effect), and further optional sensory effect generators may be external components of the tour system.

Information and data is exchanged by the system components, e.g. the tour device may send data to a central processor FIG. 1, 30 and FIG. 2, 10 of the system that collects, saves, and optionally allows to display information on location, progress through the tour, and optionally uploads some or all data to a web server. The data may include, for example, tour progress, POI's encountered, and any data relating to the one or more location element, and the one or more sensor element. For example, audio hints or feedback received, or a user's reactions/interactions. If a camera is used as location or sensor element, some or all data may be automatically recorded, and the data may optionally be transmitted to a computer as described herein, e.g. by video streaming. Optionally, the tour device may be configured with one or more additional connectivity options, and be configured to be operably connected to, e.g. a user's smartphone, 35; tablet 40; computer 45 of FIG. 1 and mixed/augmented/virtual reality hardware.

Turning to FIG. 3, the tour system may be configured for remote interactions, e.g. by a module of the tour system, or by a human tour operator to allow flexible adaptations of the tour experience. The system may also be configured for remote interactions with one or more other tour devices of one or more other users as depicted in FIG. 3, e.g. of a particular group of people sharing the tour experience, of all tour participants, 5 and 10 or of human actors/operators that form part of the tour experience. Approaching another tour device may trigger sensory effects 15 the same way that a regular Point of Interest (POI) does, as explained in more detail herein-below, e.g. other tour devices may be identified as mobile POIs in the POI data store 20 and 25, optionally with particular associated sensory effects that may depend on which group member is encountered. For example, each tour device may be configured with a location element as well as a corresponding reader/sensor, e.g. a RFID tag as well as an RFID reader, or alternatively, a GPS system may determine proximity of both tour devices via a central system component, e.g. one or more data processor connected to a plurality of tour devices.

The points of interest (POI) may be stored in a POI data store of the tour system, e.g. a general purpose computer configured to fit the dimensions of the tour device with location element that is carried by the user. Alternatively, the POI data store may be part of the external components of the tour system.

As depicted in FIG. 4, using the POI data store 5 as reference, the tour system may locate one or more POIs 10 that are close to a user as the user moves in space with the location element 15 (and optionally the sensor element 20), and automatically triggers one or more matching sensory effect 21 or feedback based on the proximity to, orientation towards, or direction of movement towards the one or more POI. Upon reaching the vicinity of a particular POI, the tour system through its trigger module 25 may trigger a particular sensory effect. The sensory effect may be triggered just by proximity to a POI (e.g. a certain distance from it), and/or may depend on a change is status such as change of location or orientation, e.g. it may only be triggered when the tour device is oriented a particular way, e.g. in the direction of a particular POI, for example by pointing towards it, and the effect may cease when pointing away from the particular POI, to provide interactive directional feedback. Optionally, the POI data store may also include timed events that may trigger a sensory effect, e.g. based on the start time of a tour, tour duration, time after reaching a POI, time estimated to reach the next POI, or similar.

In FIG. 4, the tracking module 30 is configured to track the location element 15 that is carried by a user (e.g. as part of a tour device, or as a tag that attaches to a user's clothes or body), and to determine the location element's location, optionally determine its orientation. An optional feedback module 35 may determine changes in status of the one or more sensor element, such as, without limitation, changes in the sensor element's location status or orientation status (e.g. as detected by an accelerometer or gyro sensor). The tracking module, 30 and the optional feedback module, 35 and the tour system components are preferably configured to allow these determinations, especially changes in status, to be made in real time, or in near-real time, to provide a fully immersive experience. ‘Lag time’ indicators that collect data after the location element has passed a point such as a bar code, choke point or gate often have the disadvantage of a slow response that may limit interactive feedback options and full immersion into a tour experience, especially if active input by a user is required. Some passive tracking systems may be configured to automatically determine the location, and optionally orientation, and changes thereof. Some tracking systems may have the capability to determine the orientation of the tour device, otherwise, in some embodiments, additional sensor elements (e.g. accelerometer, gyro sensor) may be used to determine orientation (or change in orientation, e.g. in a feedback module of the tour system). A large variety of tracking systems are known and useful for the present invention, as will be apparent to the ordinary person skilled in the art.

A multitude of methods and systems for tracking various products (cars, pharmaceuticals, livestock etc.) are known and publicly available and may be used in the present invention if sufficiently responsive (near real-time, preferably real-time). ‘Real-time’ or ‘near real-time’ systems may include e.g. Global Positioning Systems (GPS) with frequent refreshing of data. Many other automatic identification and data capture (AIDC) techniques are known and include Electronic Product Code (EPC) systems, active real time locating systems (RTLS), and Radio-frequency identification (RFID) systems, and Electronic Article Surveillance (EAS) systems. A tracking system may be camera-based, and the computer may use computer vision programs/Artificial intelligence and AI computer components to identify POI, including tour operators, actors, group members and other people. (And, perhaps, streaming/recording video to a computer). The tracking system or method may be camera-based, and the computer may use computer vision programs/Artificial intelligence and AI computer components to identify POI, including tour operators, actors, group members and other people. (And, perhaps, streaming/recording video to a computer.

Real-Time Location System (RTLS) automatically identifies and tracks the location of a location element in real time, typically within a building or other contained area. RTLS is a form of local positioning system, and location information usually does not include speed, direction, or spatial orientation. Wireless RTLS tags serve as location elements. In some RTLS, fixed reference points receive wireless signals from tags to determine their location. Some RTLS use radio frequency (RF) communication, others use optical (usually infrared) or acoustic (usually ultrasound) technology instead of or in addition to RF. Tags and optional fixed reference points may be transmitters, receivers, or both, resulting in numerous possible combinations.

Radio-frequency identification (RFID) or OPID (Optical RFID) are used in many industries to track products through the production line and warehouses, uses electromagnetic fields to automatically identify and track a tag that contains electronically stored information. Unlike a barcode, the tag need not be within the line of sight of the reader, so it may be attached or embedded. Passive tags collect energy from a nearby RFID reader's interrogating radio waves, while active tags have a local power source/battery and may operate hundreds of meters from the RFID reader. An alternative to RFID is OPID or optical RFID, which is based on radio frequencies in the electromagnetic spectrum, and communicates tag information to a reader by reflecting the read request, or alternative to the reflection mode, by use of active circuits, replacing RFID antennae with photovoltaic components and IR-LEDs.

Electronic Article Surveillance (EAS) systems are widely employed in retail and other stores to track an article and prevent shoplifting. EAS systems include electromagnetic, acousto-magnetic, and radio frequency systems to track specific tags. For radio frequency systems typically an LC tank circuit is used as a tag.

Camera-based tracking systems include a variety of video surveillance systems, in particular AI-based machine vision systems. Such systems may be programmed with a series of algorithms to detect certain objects (rule-based systems), or may be self-learning, i.e. learn to detect certain objects in a training phase or during use (non-rule based systems). Computers for use with a camera- and AI-based system usually include a dedicated image/video processor, and one or more specialized computer software program that analyzes images to detect objects based on various characteristics, in addition to the general components of a computer/computer system as described herein-below.

In FIG. 4, the trigger module 25 is configured to trigger a sensory effect in a sensory effect generator, 40 and is operably connected to the POI data store 5 and configured to receive POI data. The trigger module 25 is also operably connected to the tracking module 30 and optional feedback module, 35 and is configured to receive location data and optionally orientation data, and optionally status changes in location or orientation. The trigger module 25 may use any suitable programming language and may be configured on a microchip or general purpose computer, as will be apparent to the ordinary person skilled in the art. The trigger module may be part of a tracking system as described herein-above, and may receive and transmit data accordingly, e.g. via radio waves, in case of a RFID system.

In FIG. 4, the sensory effect generator 40 is configured to generate a sensory effect, 45 or a sequence of timed or interactive sensory effects as defined in the POI database. By way of the optional feedback module 35, the sensory effect 45 may take the particular form of interactive sensory feedback. The type of sensory effect generator depends on the desired sensory effect, as will be apparent to the ordinary person skilled in the art. Illustrative examples include light sources such as lamps that may have different modes, or projections systems to project images or video onto a suitable surface for visual effects, fog machines for haptic effects, sound systems for acoustic effects.

In FIG. 4, if a sensory effect generator 40 is part of the tour device, the trigger module 25 may be configured to use a signal of a first sensory effect generator to trigger a second or a further sensory effect generator, e.g. if the sensory effect generator of the tour device is a lamp, one or more POI may be equipped with a light sensor to trigger a secondary sensory effect, e.g. a light beam from a lamp may trigger a fog machine 50 to provide fog 45.

Tours may include tours through museums, parks, entertainment parks, nature parks, historical and archaeological sites. The tour device may enhance guided tour offered by a tour guide, or may provide a self-guided tour with some user input, or an automatically guided tour without or with minimized deliberate user input, for a fully immersive experience. Examples include game experiences, hay rides, scavenger hunts, haunted houses, corn and other mazes, escape rooms, theme parks, theme park rides (e.g. roller coaster), dark rides, indoor and outdoor entertainment experiences, augmented reality experiences, mixed reality experiences, and virtual reality experiences.

Preferably, the design of the tour device and, if the sensory generator is on board of the tour device carried by the user, also the selection of the sensory effect generator, should fit the theme of the tour to facilitate the fully immersive experience. For example, for an Egyptian-themed tour, e.g. in a museum, the tour device may be a canopic jar or statute, and may provide audio and/or video, and interact with the displays in the museum as POIs. For fantasy-themed tours, the tour device may be a spell book with passages that light up. For magic-themed tours, the tour device may be a magical wand that upon moving it in certain ways or giving certain voice commands to cast a spell creates different sensory effects, e.g. opening locked doors with a wave of the wand or saying “Open sesame”. For Halloween tours, haunted house tours, Dracula- and other themed nighttime experiences performed in the dark, the sensory effect generator may be a light source such as a lamp or lantern. The form factor and design of the lantern will be chosen to fit the tour experience, and its different modes that can be triggered by the trigger module may include the lantern flickering and going out (optionally coordinated with an external sensory effect generator, e.g. a fan or wind machine at the POI), or at a particularly dramatic POI (e.g. appearance of a main character such as Dracula) the lantern may strobe the light to create disorientation, or change its overall color to create a certain mood, e.g. to a red hue to alert to danger. Depending on the change in status, e.g. orientation of the sensor element and thus tour device as determined by the feedback module, the lantern may provide a sensory feedback accordingly, e.g. turn its light to red whenever turned towards a particular POI such as Dracula. The feedback feature may also help to guide a user through the tour area, e.g. in a maze or during a scavenger hunt, providing sensory clues based on changes in the tour device orientation, e.g. if the lantern is waved in direction towards an exit, or towards the next stop/POI of a tour, the light may change in one of its characteristics, e.g. its frequency and blink more quickly or more slowly, or the color may turn green, or in case of audio feedback, different audio hints may be given for different orientations or upon moving towards (or away from) a POI. In further embodiments, the light source may be attached or connected to the tour device in such a manner that allows for the light source to automatically move and point in a specific direction. For instance, a light source in a tour device that is in the form of a lantern may be actuated (e.g., such as by motorized means) and allow for the light source to change direction and point in the direction of a path the user should follow to reach the next POI in the tour.

The sensory effects broadly encompass any effects that can be perceived by the human senses and can be generated by the sensory effect generator. For example, effects may be visual, acoustic/sound, haptic, smell/scent, and temperature effects. Visual effects may include light of one or more color, moving light, oscillating light, strobe, kaleidoscope light, and light projections. Sound effects may include human speech, music, nature sounds, animal sounds, sounds of the ocean, sound of rain, bird song, insect chirping. Haptic effects may include vibration, fog, sprinkled or forcefully expelled liquids, solutions and dispersions (water, drinks, paint). Smell or scent effects include fragrance or fragrant materials dispensed into the ambient air (e.g. by spraying or with help of a fan). Temperature effects include heat, infrared radiation, and A/C, and may be directed in direction towards the location element using a directional heat source (infrared lamp) and/or fan. A movement effect that is perceivable by one or more senses (visual, haptic) may be actuated by a power source selected from motor, solenoid, and electricity, wherein optionally the movement actuated is an opening and closing of locks, an operation of a drone or robot, and the projection of an image or video. Further examples are discussed herein below to provide interactive sensory feedback.

In FIG. 4, the optional feedback module 35 is configured to determine a status change in the one or more sensor element, 20 and via the trigger module 25 and sensory effect generator 40 provide interactive feedback that immediately changes with status changes of the sensor element, e.g. its location or orientation. The feedback module is operably connected to the POI data store, 5 may be configured to receive the proximity and orientation towards one or more POI from the tracking module.

Optionally, the tour device may be configured with one or more sensor elements to determine status changes, including but not limited to changes in location or orientation (e.g. motion or vibration). Such sensor elements include e.g. a accelerometer, and a gyro sensor. The sensor elements are operably connected to the other tour system components (including the trigger module, POI data store, and sensory effect generator) to allow a user to interact through e.g. vibration or movement of the device (changes in the tour device's orientation/location), rather than a change in overall location. For example, certain movements such as shaking the device (optionally at a particular location) may trigger interactive sensory effects after determination by the feedback module. Alternatively, bouncing the device while running, or traversing bouncy surfaces (trampoline, bounce house), traversing/climbing particular obstacles (rope bridge), may automatically, without deliberate user input (but optional determination of the location of the location element) trigger certain interactive sensory effects after determination by the feedback module. For example, on a swaying rope bridge, in-theme audio may be played, e.g. dramatic music or voice audio (“Don't fall”), or useful hints to guide to the next POI (“Continue left after this bridge”/“Your red or pulsing light/acoustic guardian etc will guide you”). In other embodiments, the tour device may be configured to trigger sensory effects based on deliberate gestures such as shaking or waving the tour device. Optionally, the tour device may be configured with an acoustic sensor element or microphone, to allow a user to interact not only through body or hand movements, but also through sound and voice. For example, noises or certain voice commands such as particular words or phrases, optionally analyzed by a voice recognition module in addition to the feedback module, may trigger certain interactive sensory feedback. Other useful sensor elements include temperature sensors/thermometer, camera systems for detection of motion and/or particular objects, and light sensors. A camera system may be AI-based, e.g. a camera-based tracking system as described herein-above. The camera system may detect a particular POI, or allow interaction with a user based on the user's actions, movements or appearance, and based on particular objects or people, including group members, that a user encounters and that the camera system detects. The feedback module may be operably connected to the camera system, and in particular, the camera-system's AI module, to allow a user to interact with the tour system based on visual input. The system may provide sensory effect as feedback as described herein, e.g. audio (“Looking good”, “Meet your tour guide”, “Meet your friends”).

The optional feedback module, and one or more sensory effect generator for providing the interactive sensory feedback typically are configured on-board the tour device. Depending on the area that the tour device is operated in, the sensory effect generator that generates sensory feedback may also be provided by dedicated external components that form part of the tour system. In this case the external component is configured for data exchange with short lag times (e.g. Wi-Fi, wireless), to provide immediate sensory feedback. Alternatively, sensory feedback may be provided by one or more dedicated portable sensory effect generator.

The interactive sensory feedback includes sensory effects triggered after determination by the feedback module and includes all sensory effects as described herein-above, depending on the immersive experience. Sensory effect generators that are useful to provide interactive sensory feedback may include a light source, vibration generator, sound generator, speaker or similar. For example, the device or portable interactive feedback element may be equipped with a light source that is able to change a plurality of characteristics, e.g. it may turn on and off, blink or be lit constantly, blink at different frequencies, adjust brightness, adjust the distance and/or width of the illuminated area, adjust the focus of the light beam, change color, strobe the light, form a kaleidoscope pattern, or switch between multiple light sources with different characteristics (color, distance/width, focus, brightness, strobe, kaleidoscope etc). As the device/portable element travels or is pointed in a particular direction (as determined by e.g. change in location that is tracked by e.g. GPS, or change in device orientation determined by a gyroscope/gyro sensor/accelerometer, or a combination), the feedback changes from one state to a second state, e.g. when a user travels toward a particular POI, it will start to blink, blink faster, or change color, to provide a clue to a near-by POI, along with directional information where to find it to the user. For themes such as Halloween, haunted houses, ghost hunt, etc. that are performed in the dark, e.g. at night or in a blacked-out facility, a light source with a plurality of different characteristics as described herein may provide an interactive immersive experience. For themes performed with light/daylight available, colored lights, projections, vibration, sounds and other sensory effects may be used. For example, a beeping sound may change frequency or pitch, or a plurality of voice messages (“Hot”/“Cold”, “Keep searching”/“Go for it”) may provide directional information. Alternatively or in addition, external feedback can be used, e.g. a series of effects (light/lamps, visual projections, sound, fog, objects moving, door locks opening).

The device may be equipped with one or more sensor element to allow the feedback module to determine the one or more sensor element's change in status, including, without limitation, location, orientation, visual detection, acoustic detection, and temperature status. For example, the status change may be a change of location/movement, e.g. towards or away from a POI, and a change in orientation, e.g. towards or away from a POI. Useful sensor elements include an accelerometer, gyroscope/gyro sensor, vibration sensor, light source, light sensor, acoustic sensor, temperature sensor, or other sensor that allows to determine a tour device's change in status, and trigger a sensory effect based on e.g. whether the tour device is pointing at a POI, or which POI the tour device is pointing at (or which POI a tour device is shining its light source on). To determine orientation of the tour device, an accelerometer and/or gyroscope (also called gyro or gyro sensor) may be used. These are common components used in most smart phones. An accelerometer measures linear acceleration of movement relative to the Earth's surface, while a gyro sensor measures the angular rotational velocity; both sensors measure rate of change. In combination, the output signal will be improved (less noise and better responsiveness). An accelerometer may measure acceleration in one, two or three orthogonal axes, and typically is used in one of three modes that include as an inertial measurement of velocity and position, as a sensor of inclination, tilt or orientation in two or three dimension, as referenced from the acceleration of gravity, as a vibration or impact/shock sensor. Alternative sensors to detect vibration are well known and include piezoelectric sensors. The light source may be used with an external light sensor at or near a POI to determine whether the device is pointed at it. The light may or may not be visual light. A temperature sensor may also be used and allow to provide interactive feedback tailored to a user's activity level. An acoustic sensor (optionally operably connected with a voice recognition module) may be used to determine noise, and acoustic interactions or voice commands by the user.

A computer appropriate to form part of embodiments of the tour system is generally comprised of a Central processing Unit (CPU) with one or more central processing unit (CPU), a Random Access Memory (RAM), a storage medium (e.g., hard disk drive, solid state drive, flash memory, cloud storage), an operating system (OS), one or more application software, one or more programming languages, and one or more input/output devices/means including one or more communication interfaces (e.g., RS232, Ethernet, Wifi, Bluetooth, USB). Useful examples include, but are not limited to, microchips, personal computers, smart phones, laptops, mobile computers, tablet PCs, and servers. Multiple computers can be operably linked to form a computer network in a manner as to distribute and share one or more resources, such as clustered computers and server banks/farms. Various examples of such general-purpose multi-unit computer networks suitable for embodiments of the invention, their typical configuration and many standardized communication links are well known to one skilled in the art.

In case of a computer network such as a WAN or other network, exchange of data or information may occur through one or more high speed connections. In some cases, high speed connections may be over-the-air (OTA), passed through networked systems, directly connected to one or more WANs or directed through one or more optional router. A server may connect in numerous ways to a WAN or other network for the exchange of information, and embodiments of the present invention are contemplated for use with any method for connecting to networks for the purpose of exchanging information. Particularly useful connections include high speed connections, but embodiments of the present invention may be utilized with connections of any speed, provided the overall speed requirements of a user with regard to feedback and interactive feedback are met. For interactive feedback, the connections that participate to provide the feedback should allow for speeds consistent with a real-time or near-real time experience.

Components or modules of the tour system may connect to a server via WAN or other network in numerous ways. For instance, a component or module may connect to the system i) through a computer directly connected to the WAN, ii) through a computer connected to the WAN through a routing device, iii) through one or more computers connected to a wireless access point or iv) through a computer via a wireless connection (e.g., CDMA, GMS, 3G, 4G) to the WAN. One of ordinary skill in the art will appreciate that there are numerous ways that a component or module may connect to a server via WAN or other network, and embodiments of the present invention are contemplated for use with any method for connecting to a server via WAN or other network. Furthermore, a server could be comprised of a personal computer, such as a smartphone, acting as a host for other computers to connect to.

The tour system may comprise communications means that may be any means for communicating data, voice or video communications over one or more networks or to one or more peripheral device attached to the system, or to a system module or component, in multiple directions. Appropriate communications means may include, but are not limited to, wireless connections, wired connections, cellular connections, data port connections, Bluetooth® connections, or any combination thereof. One of ordinary skill in the art will appreciate that there are numerous communications means that may be utilized with embodiments of the present invention, and embodiments of the present invention are contemplated for use with any communications means.

Traditionally, a computer program consists of a finite sequence of computational instructions or program instructions. It will be appreciated that a programmable apparatus or computer can receive such a computer program and, by processing the computational instructions thereof, produce a technical effect.

A programmable computer includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on. It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the described functions. This particular machine (or networked configuration thereof) provides a means for carrying out any and all of the functions described herein.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Specific illustrative examples of the computer readable storage medium may include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements, means and functions of a computer, computer system, including any of its periphery, components, connection means and communication means described herein-above may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that the elements, means and functions support combinations for performing the specified functions, combinations of steps for performing the specified functions, program instruction means for performing the specified functions, and so on.

It will be appreciated that the tour system modules may comprise computer program instructions and may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

The functions presented herein are not inherently related to any particular computer or other apparatus. Various general-purpose systems may also be used with programs in accordance with the teachings herein, or it may prove convenient to construct more specialized apparatus to perform the required functions or method steps. The required structure for a variety of these systems will be apparent to those of ordinary skill in the art, along with equivalent variations. Embodiments of the invention are well suited to a wide variety of computer network systems over numerous topologies. Within this field, the configuration and management of large networks include storage devices and computers that are communicatively coupled to dissimilar computing and storage devices over a network, such as the Internet.

Each function described can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While multiple embodiments are disclosed, still other embodiments of the present invention will become apparent to those skilled in the art from this detailed description. There may be aspects of this invention that may be practiced without the implementation of some features as they ar33e described. It should be understood that some details have not been described in detail in order to not unnecessarily obscure the focus of the invention. The invention is capable of myriad modifications in various obvious aspects, all without departing from the spirit and scope of the present invention. Accordingly, the drawings and descriptions are to be regarded as illustrative rather than restrictive in nature.

1. A tour system comprising a location element configured to be carried by a user of the system, wherein the tour system comprises a tour device that is operably connected to a plurality of operably connected system components comprising:
a data processor,
a point of interest (POI) data store,
a tracking module,
a trigger module,
a sensory effect generator,
and optionally a feedback module;
wherein each of the system components is either configured in the tour device and the tour device itself thus forms the tour system, or is configured in one or more external devices that are operably connected to the tour device and together with the tour device collectively form the tour system;
wherein the POI data store comprises a list of POI and corresponding data that defines one or more sensory effects including sequence and timing of the one or more sensory effects,
wherein the tracking module is operably connected to the POI data store, is configured to receive location data from the location element, and determine the location element's proximity to one or more POI, and optionally the orientation of a sensor element towards one or more POI; and
wherein the optional feedback module is operably connected to the POI data store, is configured to receive status data from the one or more sensor element, and determine a change in the one or more sensor element's status including a change in location, orientation, visual detection, acoustic detection and temperature;
wherein the trigger module is operably connected to the tracking module, to the optional feedback module, and to the sensory effect generator, and triggers the generation of the one or more sensory effects by the sensory effect generator depending on the tracking module's or the optional feedback module's determination of a location element's proximity to a POI, a location element's orientation towards a POI, and a sensor element's status change;
wherein the sensory effect generator generates the one or more sensory effects as defined in the POI data store.

2. The tour system of claim 1 wherein the trigger module triggers the generation of the sensory effect depending on one or more of the tracking module's or the feedback module's determination of the location element's proximity to one or more POI, the location element's orientation towards one or more POI, and a sensory element's status change.

3. The tour system of claim 1, wherein the tour system is a stand-alone personal device.

4. The tour system of claim 1, wherein the tour system comprises a plurality of system components.

5. The tour system of claim 1, wherein one or more sensory effect generator is configured in the tour device.

6. The tour system of claim 1, wherein a feedback module is configured in the tour device.

7. The tour system of claim 1, wherein the tour system is configured with one or more external sensory effect generator.

8. The tour system of claim 1, wherein each of the one or more sensory effects is selected from the group comprising visual, acoustic, haptic, smell/scent, and temperature.

9. The tour system of claim 1, wherein one of the sensory effects is visual, and includes light of one or more color, moving light, oscillating light, strobe, kaleidoscope light, and light projections.

10. The tour system of claim 1, wherein one of the sensory effects is sound, and includes human speech, music, nature sounds, animal sounds, sounds of the ocean, sound of rain, bird song, insect chirping.

11. The tour system of claim 1, wherein one of the sensory effects is haptic, and includes vibration, fog, sprinkled or forcefully expelled liquids,

12. The tour system of claim 1, wherein one of the sensory effects is smell or scent, and includes fragrance or fragrant materials dispensed into the ambient air.

13. The tour system of claim 1, wherein one of the sensory effects is temperature, and includes heat, infrared radiation, and cold air blown by an A/C.

14. The tour system of claim 1, wherein each of the one or more sensory effects is created by movement actuated by a power source selected from motor, solenoid, and electricity, wherein optionally the movement actuated is an opening and closing of locks, an operation of a drone or robot, and the projection of an image or video.

15. A method that comprises the steps of:
tracking, in a tracking module configured in a tour system, a location and optionally an orientation of a location element configured to be carried by a user of the tour system; and
determining, in the tracking module, the location element's proximity to one or more Point of interest (POI), and optionally the sensor element's orientation towards the one or more POI; and
optionally determining, in a feedback module, a change in one or more status in the one or more sensor element including a change in location, orientation, visual detection, acoustic detection and temperature; and
triggering, in a trigger module configured in the tour system, one or more sensory effect generator to provide a sensory effect or sequence of timed or interactive sensory effects as defined in a POI data store based on one or more determination by the tracking module, and optionally based on one or more determination by the feedback module;
wherein the tour system comprises a tour device that is operably connected to a plurality of operably connected system components comprising a data processor, a point of interest (POI) data store, a tracking module, a trigger module, a sensory effect generator, and optionally a feedback module;
wherein each of the system components is either configured in the tour device and the tour device itself thus forms the tour system, or is configured in one or more external devices that are operably connected to the tour device and together with the tour device collectively form the tour system;
wherein the POI data store comprises a list of POI and corresponding data that defines one or more sensory effect including sequence and timing of the one or more sensory effect,
wherein the tracking module is operably connected to the POI data store, is configured to receive the location of the location element, and optionally the orientation of the one or more sensor element; and
wherein the optional feedback module is operably connected to the POI data store, and is configured to receive a status change of the one or more sensor element; and
wherein the trigger module is operably connected to the tracking module, the optional feedback module, and the sensory effect generator.

16. The method of claim 15, wherein the trigger module triggers the generation of the sensory effect depending on one or more of the tracking module's or the feedback module's determination of the location element's proximity to a POI, the location element's orientation towards a POI, and the one or more sensor element's change of status.

17. The method of claim 15, wherein the tour system is a stand-alone personal device.

18. The method of claim 15, wherein the tour system comprises a plurality of system components.

19. The method of claim 15, wherein one or more sensory effect generator is configured in the tour device.

20. The method of claim 15, wherein a feedback module is configured in the tour device.

21. The method of claim 15, wherein the sensory effect is selected from the group comprising visual, acoustic, haptic, scent, and temperature.

22. The method of claim 15, wherein the sensory effect includes light of one or more color, moving light, oscillating light, strobe, kaleidoscope light, and light projections, human speech, music, nature sounds, animal sounds, sounds of the ocean, sound of rain, bird song, insect chirping, vibration, fog, sprinkled or forcefully expelled liquids, fragrance or fragrant materials dispensed into the ambient air, heat, infrared radiation, cold air blown by an A/C, movement actuated by a power source selected from motor, solenoid, and electricity, opening and closing of locks, an operation of a drone or robot, and the projection of an image or video.
